(19) United States
(12) Patent Application Publication
(10) Pub. No.: US 2014/0077110 A1
(43) Pub. Date: Mar. 20, 2014

(54) CONNECTOR ASSEMBLY FOR MEDICAL GAS APPLICATIONS

(71) Applicants: Stephan Gamard, Clarence, NY (US); Gerald C. Squires, Clarence Center, NY (US); Mark Alstadt, Solon, OH (US); Bruce Wick, Avon Lake, OH (US)

(72) Inventors: Stephan Gamard, Clarence, NY (US); Gerald C. Squires, Clarence Center, NY (US); Mark Alstadt, Solon, OH (US); Bruce Wick, Avon Lake, OH (US)

(21) Appl. No.: 14/016,315

(22) Filed: Sep. 3, 2013

Related U.S. Application Data
(60) Provisional application No. 61/701,957, filed on Sep. 17, 2012.

(51) Int. Cl. F16L 37/28; F16L 43/00

(52) U.S. Cl. CPC F16L 37/28; F16L 43/00
USPC 251/149.1; 285/179

(57) ABSTRACT

A connector assembly for connecting a medical gas cylinder with a medical gas delivery device is provided. The connector assembly includes a jacketed hose connected at one end to a gas delivery device adaptor and connected at the other end to a male quick coupling element that connects with a cylinder coupling valve assembly. The valve assembly includes a retainer body assembly and a retainer sleeve that define a female quick coupling portion adapted to receive the male type quick coupling element of the hose assembly. The gas delivery device adaptor is an elbow shaped body with an internally disposed 90 degree threaded bore from its distal end to its proximal end. An engagement stem projects from the distal end of elbow shaped body and is adapted to couple the gas delivery device to the jacketed hose via the 90 degree threaded bore.

### CROSS REFERENCE TO RELATED APPLICATIONS

This application claims the benefit of and priority to U.S. Provisional Patent Application Ser. No. 61/701,957 filed on Sep. 17, 2012 the disclosure of which is incorporated by reference herein.

### FIELD OF THE INVENTION

The present invention relates generally to connector assemblies, and more particularly to medical gas connector assemblies utilized in hospitals and the like for coupling medical gas cylinders to an authorized or approved medical gas delivery device.

### BACKGROUND

In the field of medical gas connector assemblies like those utilized in hospitals for dispensing medical gases such as nitrous oxide, heliox, carbon dioxide, medical air, oxygen, nitric oxide, etc., it is clear that it would be of considerable advantage to have a rapidly attachable connector device that ensures the proper medical gas cylinder is connected to the appropriate medical devices so as to prevent inadvertent or accidental coupling of the wrong gas to a medical gas delivery device. This is particularly true in case of emergencies, where oxygen, heliox, or other medical gas may have to be administered very quickly.

While there are numerous medical gas fittings available in the medical gas field, including fittings made by the following vendors: Puritan, Schrader, Ohmeda, Chemetron, Oxequip, and DISS. Each of these medical gas fittings have unique configurations so as to differentiate the various products in the marketplace. In addition, many of the above-identified vendors provide color differentiation for fittings associated with different types of medical gases as well as configuration differences between the different fittings to prevent accidental connections of a wrong gas cylinder to the fitting.

Many of the fittings from the above-identified vendors are bayonet type fittings to ensure correct mating and locking with the appropriate gas cylinder or gas source. However, there are certain inherent disadvantages to the bayonet type construction. For example, the bayonet type fitting requires the user to correctly align the male and female portions, and this requires a careful inspection of the parts to ensure that the initial introduction of the male member will be accomplished in the correct orientation. Also, after insertion of the male member, the user must often rotate the male member in the correct direction in order to engage the bayonet joint. In an emergency situation, it is obvious that the less the user is concerned about the mechanics of engaging the coupling, the better. Ideally, the user should be able to simply shove the male member into the female member, and accomplish a snap engagement.

Still other of the above-identified medical gas fittings are quick connect type or quick disconnect type fittings with specially designed notches, pins, grooves and/or apertures to ensure correct mating and latching with the appropriate gas cylinder or gas source. However, these conventional fitting assemblies are targeted to generically address the safe coupling of a hose, conduit or breathing circuit to the correct cylinder and/or gas supply and do not ensure the gas supply is properly connected at the other end to an appropriate medical gas delivery device.

What is needed therefore is a medical gas connector assembly that provides safe, effective and unique connections at both the gas source end as well as the gas delivery end to ensure the gas delivery device is safely connected to the proper gas cylinder or gas source.

### SUMMARY OF THE INVENTION

The present invention may be characterized as a connector assembly for connecting a gas cylinder with a gas delivery device. The present connector assembly comprises: (i) a hose assembly having a jacketed hose connected at one end to a gas delivery device adaptor and connected at the other end to a male quick coupling element; and (ii) a cylinder coupling valve assembly having a main body portion, a retainer body assembly, and a retainer sleeve, the retainer body assembly and retainer sleeve defining a female quick coupling portion configured to receive the male quick coupling element of the hose assembly; and (iii) a gas delivery device adaptor having an elbow shaped body with a distal end and proximal end and defining an internally disposed 90 degree threaded bore from the distal end to the proximal end; and an engagement stem projecting from a distal end of elbow shaped body configured to fluidically couple the gas delivery device to the jacketed hose via the 90 degree threaded bore.

The main body portion of the cylinder coupling valve assembly has a first end configured to threadably attach to the gas cylinder or gas regulator and includes a poppet valve, a valve spring, and O-ring seal. The cylinder coupling valve assembly is configured to permit gas flow from the gas cylinder to the hose assembly when the male quick coupling element is engaged with the female quick coupling portion thereby opening the poppet valve and to prevent gas flow from the gas cylinder to the hose assembly when the male quick coupling element is removed from the female quick coupling portion. The male quick coupling element comprises a base and a stepped body having a distal end portion, a neck portion, a mid body portion, and a large diameter aft body portion, wherein the base is in an abutting relationship with the end of the retainer body assembly when the distal portion operatively engages or opens the poppet valve.

The present invention may also be characterized as a hose assembly for a gas delivery device comprising: (i) a gas delivery device adaptor having an elbow shaped body with a distal end and a proximal end and at least one exterior flat surface and defining an internally disposed 90 degree threaded bore between the distal end and the proximal end to permit gas to flow therethrough and an engagement stem projecting from the distal end of elbow shaped body configured to engage with the gas delivery device; and (ii) a jacketed hose connected at one end to the proximal end of the gas delivery device adaptor and configured to be connected at the other end to a gas cylinder or other gas source.

The present invention may also be characterized as a quick connect gas cylinder assembly comprising: (i) a cylinder coupling valve assembly having a main body portion, a retainer body assembly, and a retainer sleeve, the retainer body assembly and retainer sleeve defining a female quick coupling portion; (ii) a male quick coupling element comprising a base and a stepped body having a distal end portion, a neck portion, a mid body portion, and a large diameter aft body portion, wherein the base is in an abutting relationship with an end of the retainer body assembly when the distal portion operatively engages or opens the poppet valve in the main body portion of the cylinder coupling valve assembly. The neck portion of the male quick coupling element is configured to aligned with one or more ball bearings disposed in the female quick coupling portion of the cylinder coupling valve assembly and the mid body portion and large diameter aft body portion are slideably disposed within corresponding spaces within the retainer sleeve, and wherein the engagement of the neck portion and the ball bearings holds the male quick coupling element within the female quick coupling portion.

The main body portion of the cylinder coupling valve assembly has a first end configured to threadably attach to a gas cylinder or gas regulator and includes a poppet valve, a valve spring, and O-ring seal. The quick connect gas cylinder assembly is configured to permit gas flow from the gas cylinder when the male quick coupling element is engaged with the female quick coupling portion thereby opening the poppet valve and to prevent gas flow from the gas cylinder when the male quick coupling element is removed from the female quick coupling portion;

### BRIEF DESCRIPTION OF THE DRAWINGS

The above and other aspects, features, and advantages of the present invention will be more apparent from the following, more detailed description thereof, presented in conjunction with the following drawings, wherein:

FIG. 1 is a schematic illustration of an embodiment of the connector assembly in accordance with the present invention;

FIG. 2 is an illustration of the medical gas delivery device adaptor used in embodiments of the present invention;

FIG. 3 is an illustration of the cylinder coupling valve and the quick coupling element used in embodiments of the present invention;

FIG. 4 is a cross sectional view of the cylinder coupling valve of FIG. 3;

FIG. 5 is a cross sectional view of the quick coupling element of FIGS. 3; and

FIG. 6 is a schematic illustration of another embodiment of the connector assembly in accordance with the present invention.

### DETAILED DESCRIPTION

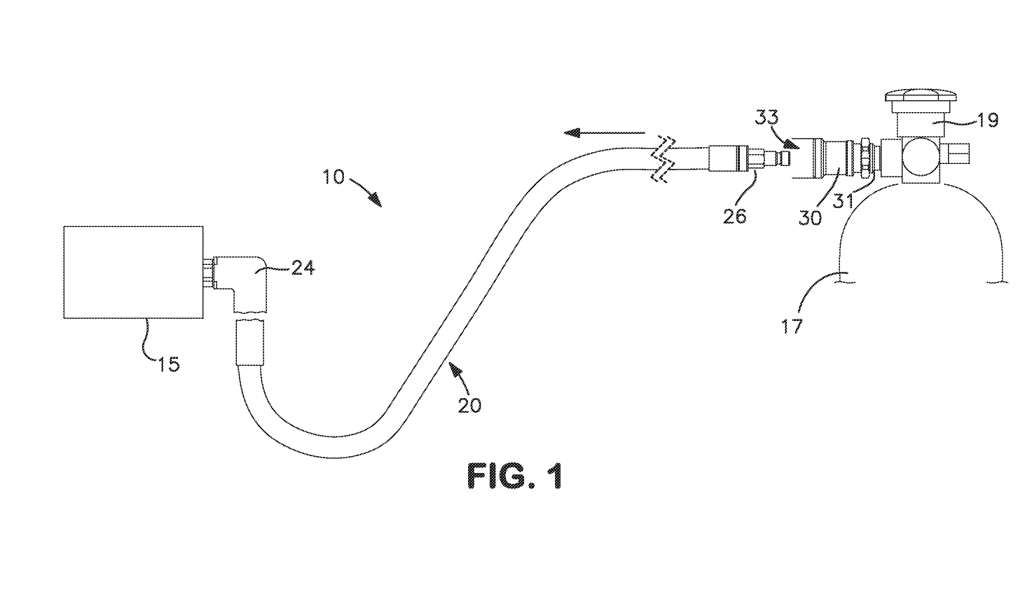

Turning now to the drawings and in particular FIG. 1, there is shown an embodiment of the present medical gas connector assembly 10 coupling a medical gas delivery device 15 to a medical gas cylinder 17. As seen therein, the medical gas connector assembly includes a hose assembly 20 having a jacketed hose 22 connected at one end to a medical gas delivery device adaptor 24 and connected at the other end to a male type quick coupling element 26. The connector assembly 10 further includes a cylinder coupling valve assembly 30 having a first threaded male end 31 configured to attach to the regulator 19 associated with the medical gas cylinder 17 pursuant to CGA standards. The other end 33 of the cylinder coupling valve assembly 30 is a female quick coupling portion 34 configured to receive the quick coupling element 26 of the hose assembly 20.

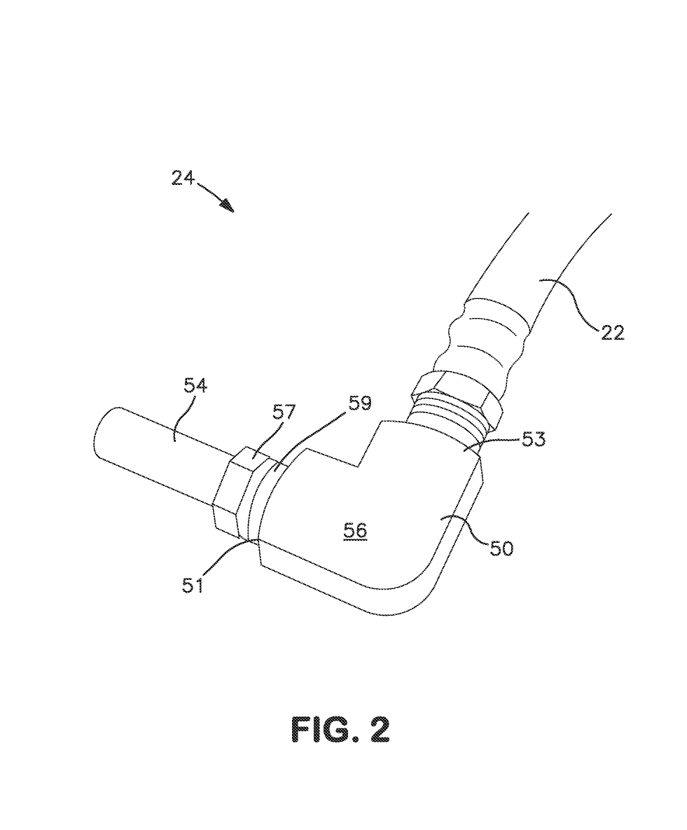

As more clearly seen in FIG. 2, the medical gas delivery device adaptor 24 has an elbow shaped body 50 with a 90 degree threaded bore or fluid path (not shown) extending from the distal end 51 of the body 50 through the interior of the body 50 to a proximal end 53 where the body 50 is coupled to the jacketed hose 22 via a threaded connection. An engagement stem 54 projects from the distal end 51 of elbow shaped body 50 and is configured to fluidically engage or couple the medical gas delivery device 15 with the elbow body 50 and the jacketed hose 22 via the interior bore or fluid path. In the illustrated embodiments, the elbow shaped body 50 further includes at least one flat exterior surface 56 where designations, trademarks or other product identification labels or colors may be prominently displayed to users of the medical gas connector assembly.

The illustrated engagement stem 54 is a cylindrical tube that functions much like a push-in fitting that is sized or configured to only engage with a mating receptacle in the appropriate medical gas delivery device 15 while allowing flow of medical gas from the adaptor 24 to the delivery device 15. The stem 54 also includes a hexagonal base 57 and threaded end 59 adapted to threadably connect with the elbow shaped body 54. By customizing the size and configuration of the cylindrical stem 54, one can use the medical gas connector assembly 10 only with an authorized medical gas device 15.

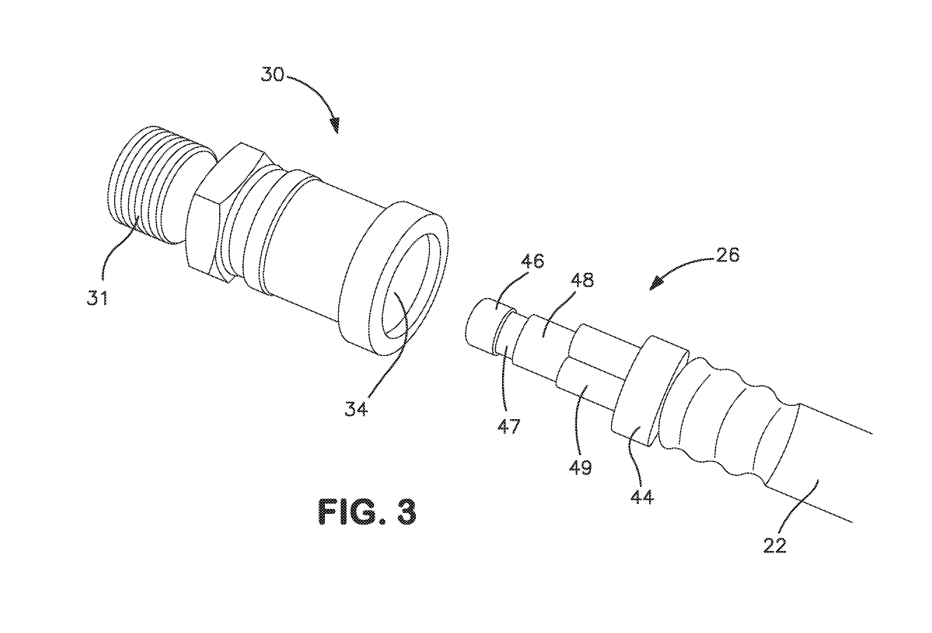

Turning now to FIG. 3, the cylinder coupling valve assembly 30 and corresponding quick coupling element 26 are shown. The cylinder coupling valve assembly 30 has a female quick coupling portion 34 configured to receive the corresponding or mating male portion of the quick coupling element 26 on one end of the jacket hose 22. The other end of the cylinder coupling valve assembly 30 is a threaded male end 31 configured to connect with the medical gas regulator.

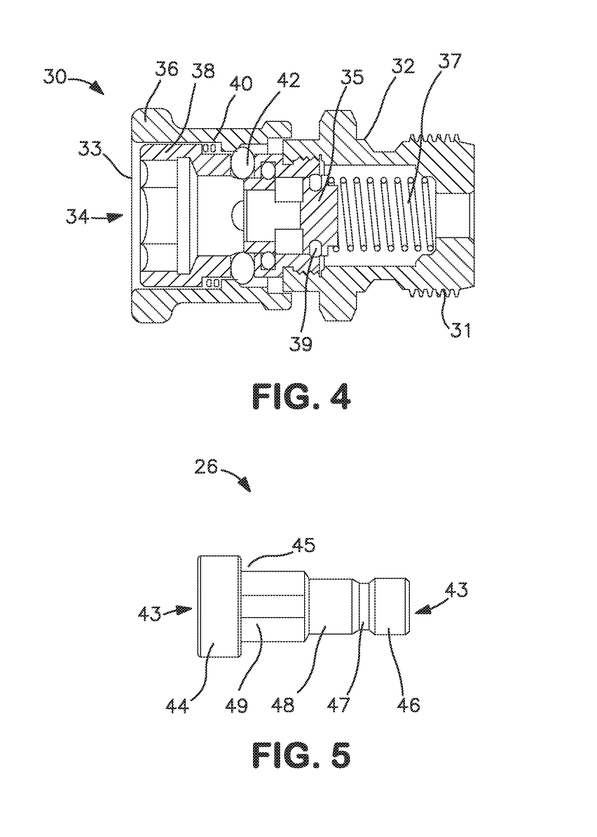

FIG. 4 shows a more detailed cross sectional view of the ‘pull to release’ cylinder coupling valve assembly 30. As seen therein, one end of the cylinder coupling valve assembly 30 has a valve main body portion 32 that includes a male threaded end 31. Within the valve main body portion 32 is a poppet valve 35, valve spring 37, and O-ring seal 39 that operatively controls the flow of gas through interior flow channels within the cylinder coupling valve assembly 30 from the male threaded end 31 to the other end 33. The other end 33 of cylinder coupling valve assembly 30 includes a retainer sleeve 38 and a retainer body assembly 36 that together defines the female quick coupling portion 34. Within the retainer body assembly 36 are a release spring 40 and ball bearings 42 that facilitate axial movement of retainer body assembly 36 within the retainer sleeve 38 as a quick connect element (not shown) engages and disengages with the female quick coupling portion 34 of the cylinder coupling valve assembly 30. The poppet valve 35 and valve spring 37 are operatively configured so as to permit gas flow from a pressurized gas cylinder (not shown) coupled to the threaded male end 31 through the valve assembly when the quick connect element engages the female quick coupling portion 34. As the quick connect element is pulled in an axial orientation away from the cylinder coupling valve assembly, it disengages from the female quick coupling portion 34 and the spring 37 forces closure of the poppet valve 35 so as to stop or prevent gas flow from the pressurized cylinder.

FIG. 5 shows a more detailed cross sectional view of the male type quick coupling element 26 used in the present medical gas connection assembly. As seen therein, the male type quick coupling element 26 includes a base 44, and a stepped body 45 with a central axial bore 43 disposed therein to allow gas flow therethrough. The illustrated stepped body 45 comprises a distal portion 46, a narrow diameter neck portion 47, a mid body portion 48, and a large diameter aft body portion 49. When fully engaged with the cylinder coupling valve assembly 30, the base 44 of the quick coupling element 26 is in an abutting relationship with the end of the retainer body assembly 36 while the distal portion 46 operatively engages or opens the poppet valve 35. When fully engaged, the narrow diameter neck portion 47 of the quick coupling element 26 is aligned with the ball bearings 42 of the cylinder coupling valve assembly 30 which holds the quick coupling element 26 within the female quick coupling portion 34. The mid body portion 48 and large diameter aft body portion 49 are slideably disposed within corresponding spaces within the retainer sleeve 38. The quick coupling element 26 is removed from the female quick coupling portion 34 of the cylinder coupling valve assembly 30 by axially pulling the quick coupling element 26 away from the valve assembly 30.

In practice, the size and type of threads on the male threaded end 31 of the cylinder coupling valve assembly 30 as well as the color of the cylinder coupling valve assembly 30 should be customized per Compressed Gas Association (CGA) standards to match or fit only selected gas cylinders so as to prevent use of the medical gas connector assembly 10 and/or the medical gas device 15 being used with the wrong gas. Similarly, the size and configuration of the engagement stem 54 is customized to only engage with a mating receptacle in the appropriate medical gas delivery device 15. In this manner, one can control or manage which gas cylinders can be used with the medical gas connector assembly 10 and/or the medical gas device 15 thus ensuring safe administration and delivery of the gas via the authorized delivery device to the patient.

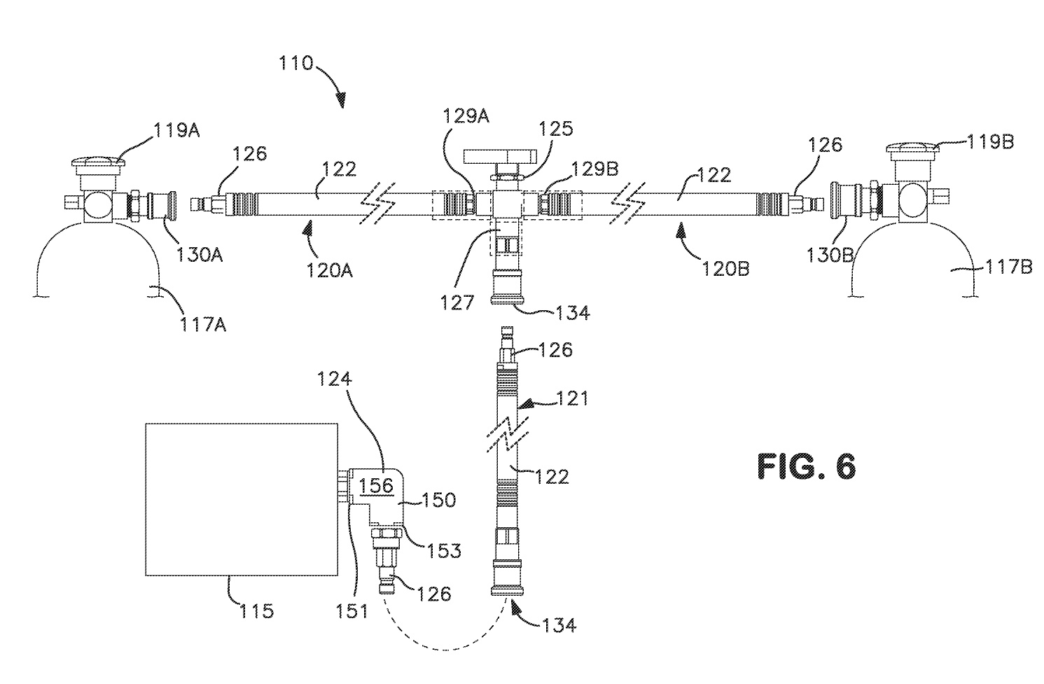

FIG. 6 shows another embodiment of the medical gas connector assembly 110 coupling a medical gas delivery device 115 to a pair of medical gas cylinders 117A, 117B and regulators 119A, 119B. As seen therein, the medical gas connector assembly 110 includes a plurality of hose segments 120A, 120B, 121, a three way switching valve 125, and a medical gas delivery device adaptor 124. Each hose segment 120A, 120B includes a jacketed hose 122 connected at one end to the three-way NPT switching valve 125 and connected at the other end to a male quick coupling element 126. Hose segment 121 includes a jacketed hose 122 connected at one end to a male quick coupling element 126 and at the other end to a corresponding female quick coupling element 134C.

The three way switching valve has two inlets 129A, 129B with NPT connections to hose segments 120A, 120B respectively, and one outlet 127 with an NPT connection to a female quick coupling element 134. The switching valve also includes a knob, actuator or other means to switch the gas flow path from the first path to a second path. Specifically, by actuating the switch valve the medical gas flow is switched from a first cylinder 117A via first hose segment 120A and first inlet 129A to the outlet 127 to a second cylinder 117B via second hose segment 120B and second inlet 129B to the outlet 127.

The connector assembly 110 further includes a pair of cylinder coupling elements 130A, 130B each having a first threaded male end 131 configured to attach to the regulator 119A, 119B associated with the medical gas cylinders 117A, 117B pursuant to CGA standards. The other end 133 of each cylinder coupling elements 130A, 130B have a female quick coupling element 134A, 134B configured to receive the male quick coupling elements 126 of hose segments 120A, 120B.

Similar to the embodiment shown in FIG. 2, the medical gas delivery device adaptor 124 has an elbow shaped body 150 with a 90 degree threaded bore or fluid path (not shown) extending from the distal end 151 of the body 150 through the interior of the body 150 to a proximal end 153 where the body 150 is coupled to a male type quick coupling element 126 configured to connect with the corresponding female quick coupling portion 134 of hose segment 121. The medical gas delivery device adaptor 124 also includes an engagement stem (not shown) that projects from the distal end 151 of elbow shaped body 150 and is configured to fluidically engage or couple medical gas delivery device 115 with elbow body 150, hose segment 112, and three way valve 125.

As with the earlier described embodiments, the elbow shaped body 150 further includes at least one flat exterior surface 156 where designations, trademarks or other product identification labels may be prominently displayed to users of the medical gas connector assembly 110. The cylinder coupling element 130A, 130B together with the female quick coupling portions 134A, 134B, 134C and corresponding male type quick coupling elements 126 are also similar to the earlier described embodiments (See FIG. 3).

From the foregoing, it should be appreciated that the present invention thus provides a gas connector assembly for specialized coupling of pressurized gas cylinders to selected gas delivery devices. While the invention herein disclosed has been described by means of specific embodiments, numerous modifications and variations can be made thereto by those skilled in the art without departing from the scope of the invention as set forth in the claims or sacrificing all of its features and advantages.

1. A connector assembly for connecting a gas cylinder with a gas delivery device, the connector assembly comprising
a hose assembly having a jacketed hose connected at one end to a gas delivery device adaptor and connected at the other end to a male quick coupling element;
a cylinder coupling valve assembly having a main body portion, a retainer body assembly, and a retainer sleeve, the retainer body assembly and retainer sleeve defining a female quick coupling portion configured to receive the male quick coupling element of the hose assembly
wherein the main body portion has a first end configured to threadably attach to the gas cylinder or gas regulator and includes a poppet valve, a valve spring, and O-ring seal disposed in the main body portion and configured to permit gas flow from the gas cylinder to the hose assembly when the male quick coupling element is engaged with the female quick coupling portion thereby opening the poppet valve and to prevent gas flow from the gas cylinder to the hose assembly when the male quick coupling element is removed from the female quick coupling portion;
wherein the male quick coupling element comprises a base and a stepped body having a distal end portion, a neck portion, a mid body portion, and a large diameter aft body portion, wherein the base is in an abutting relationship with the end of the retainer body assembly when the distal portion operatively engages or opens the poppet valve; and
wherein the gas delivery device adaptor further comprises an elbow shaped body defining an internally disposed 90 degree threaded bore; and an engagement stem projecting from a distal end of elbow shaped body, the engagement stem configured to fluidically couple the gas delivery device to the jacketed hose via the 90 degree threaded bore.

2. The connector assembly of claim 1 wherein the neck portion of the male quick coupling element is configured to aligned with one or more ball bearings disposed in the female quick coupling portion of the cylinder coupling valve assembly and the mid body portion and large diameter aft body portion are slideably disposed within corresponding spaces within the retainer sleeve, and wherein the engagement of the neck portion and the ball bearings holds the male quick coupling element within the female quick coupling portion.

3. The connector assembly of claim 1 wherein the elbow shaped body further comprises at least one flat exterior surface.

4. The connector assembly of claim 1 wherein the connector assembly is operatively connected to a plurality of gas cylinders and the hose assembly is connected at one end to the gas delivery device and connected at the other end to a plurality of male quick coupling elements, each of male quick coupling elements configured to be connected to a gas cylinder via the cylinder coupling valve assembly, and wherein the hose assembly further comprises a plurality of jacketed hoses, and at least one switching valve to switch the gas supply to the gas delivery device from amongst the plurality of gas cylinders.

5. A hose assembly for a gas delivery device comprising:
a gas delivery device adaptor having an elbow shaped body with a distal end and a proximal end and defining an internally disposed 90 degree threaded bore between the distal end and the proximal end to permit gas to flow therethrough and an engagement stem projecting from the distal end of elbow shaped body, the engagement stem configured to engage with the gas delivery device;
a jacketed hose connected at one end to the proximal end of the gas delivery device adaptor and configured to be connected at the other end to a gas cylinder or other gas source;
wherein the elbow shaped body further comprises at least one flat exterior surface.

6. A quick connect gas cylinder assembly comprising:
a cylinder coupling valve assembly having a main body portion, a retainer body assembly, and a retainer sleeve, the retainer body assembly and retainer sleeve defining a female quick coupling portion;
the main body portion having a first end configured to threadably attach to a gas cylinder or gas regulator and including a poppet valve, a valve spring, and O-ring seal disposed in the main body portion;
a male quick coupling element comprising a base and a stepped body having a distal end portion, a neck portion, a mid body portion, and a large diameter aft body portion, wherein the base is in an abutting relationship with an end of the retainer body assembly when the distal portion operatively engages or opens the poppet valve in the main body portion of the cylinder coupling valve assembly;
wherein the quick connect gas cylinder assembly is configured to permit gas flow from the gas cylinder when the male quick coupling element is engaged with the female quick coupling portion thereby opening the poppet valve and to prevent gas flow from the gas cylinder when the male quick coupling element is removed from the female quick coupling portion;
wherein the neck portion of the male quick coupling element is configured to align with one or more ball bearings disposed in the female quick coupling portion of the cylinder coupling valve assembly and the mid body portion and large diameter aft body portion are slideably disposed within corresponding spaces within the retainer sleeve, and wherein the engagement of the neck portion and the ball bearings holds the male quick coupling element within the female quick coupling portion.
